(19) United States
(12) Patent Application Publication
(10) Pub. No.: US 2009/0237868 A1
(43) Pub. Date: Sep. 24, 2009

(54) CAPACITOR DEVICE

(75) Inventors: Masanori TAKAHASHI, Sendai-shi (JP); Koji Sakata, Sendai-shiw (JP); Katsuhiro Yoshida, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 12/405,395

(22) Filed: Mar. 17, 2009

(30) Foreign Application Priority Data
Mar. 18, 2008 (JP) 2008-069520

(51) Int. Cl. H01G 9/012

(52) U.S. Cl. 361/540

(57) ABSTRACT

A capacitor device comprises first and second substrates and a capacitor element that comprises an anode portion and a cathode portion. The first substrate has a first inner surface and a first outer surface and is provided with a first inner anode terminal, a first inner cathode terminal, a first outer anode terminal and a first outer cathode terminal. The capacitor element is mounted on the first inner surface of the first substrate. The first inner anode terminal and the first inner cathode terminal are formed on the first inner surface and are electrically connected to the anode portion and the cathode portion, respectively. The first outer anode terminal and the first outer cathode terminal are formed on the first outer surface and are electrically connected to the first inner anode terminal and the first inner cathode terminal, respectively. The second substrate has a second inner surface and a second outer surface and is provided with a second inner anode terminal, a second inner cathode terminal, a second outer anode terminal and a second outer cathode terminal. The second inner surface is mounted on the capacitor element so that the capacitor element is positioned between the first and the second substrates. The second inner anode terminal and the second inner cathode terminal are formed on the second inner surface and are electrically connected to the anode portion and the cathode portion, respectively. The second outer anode terminal and the second outer cathode terminal are formed on the second outer surface and are electrically connected to the second inner anode terminal and the second inner cathode terminal, respectively.

### CROSS REFERENCE TO RELATED APPLICATIONS

Applicants claim priority under 35 U.S.C. §119 of Japanese Patent Application No. 2008-069520 filed Mar. 18, 2008.

### BACKGROUND OF THE INVENTION

This invention relates to a capacitor device which comprises a capacitor element and connection members for the capacitor element.

High operation frequency in recent years requires smoothness of power supply and tolerance to high frequency noise. To meet the requirements, a large number of capacitors each of which has large capacitance and low impedance are used in an electric apparatus. For example, several tens of ceramic capacitors are used as “decoupling capacitors or bypass capacitors” in one apparatus. Normally, the total area required to mount the capacitors thereon becomes large in accordance with the increased number of the capacitors mounted. Therefore, there is a need to a capacitor device which has large capacitance and low impedance but does not require a large implementation area therefor.

To meet the above-mentioned low impedance requirement, JP 2002-299161 discloses a hybrid device which comprises a capacitor element and an IC (integrated circuit) mounted on the capacitor element. The hybrid device of JP 2002-299161 has low impedance between the capacitor element and the IC.

To meet the above-mentioned large capacitance requirement, JP 2002-289470 discloses a capacitor device which comprises a plurality of capacitor elements stacked. In addition, an IC can be mounted and connected to the capacitor device so that low impedance between the capacitor device and the IC also can be achieved.

However, each of the disclosed capacitor devices is very specialized for its use so that the whole structure must be changed if the IC is replaced with another structured IC. In other words, the structures of the disclosed capacitor devices are not widely applicable. Therefore, there is a need to a capacitor device which has a widely applicable structure or structural concept while having large capacitance and low impedance.

### SUMMARY OF THE INVENTION

One aspect of the present invention provides a capacitor device which comprises first and second substrates and a capacitor element. The capacitor element comprises an anode portion and a cathode portion. The first substrate has a first inner surface and a first outer surface and is provided with a first inner anode terminal, a first inner cathode terminal, a first outer anode terminal and a first outer cathode terminal. The capacitor element is mounted on the first inner surface of the first substrate. The first inner anode terminal and the first inner cathode terminal are formed on the first inner surface and are electrically connected to the anode portion and the cathode portion, respectively. The first outer anode terminal and the first outer cathode terminal are formed on the first outer surface and are electrically connected to the first inner anode terminal and the first inner cathode terminal, respectively. The second substrate has a second inner surface and a second outer surface and is provided with a second inner anode terminal, a second inner cathode terminal, a second outer anode terminal and a second outer cathode terminal. The second inner surface is mounted on the capacitor element so that the capacitor element is positioned between the first and the second substrates. The second inner anode terminal and the second inner cathode terminal are formed on the second inner surface and are electrically connected to the anode portion and the cathode portion, respectively. The second outer anode terminal and the second outer cathode terminal are formed on the second outer surface and are electrically connected to the second inner anode terminal and the second inner cathode terminal, respectively.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a cross-sectional view schematically showing a capacitor device according to a first embodiment of the present invention, wherein the capacitor device comprises first and second substrates and a capacitor element.

FIG. 2 is a view schematically showing the capacitor element of FIG. 1.

FIG. 3 is a set of plan views schematically showing the first substrate of FIG. 1, wherein the left figure shows a first outer surface of the first substrate while the right figure shows a first inner surface of the first substrate.

FIG. 4 is a cross-sectional view schematically showing the first substrate of FIG. 3.

FIG. 5 is a set of plan views schematically showing the second substrate of FIG. 1, wherein the left figure shows a second outer surface of the second substrate while the right figure shows a second inner surface of the second substrate.

FIG. 6 is a cross-sectional view schematically showing the second substrate of FIG. 5.

FIG. 7 is a perspective view schematically showing a capacitor element of a capacitor device according to a second embodiment of the present invention.

FIG. 8 is a view schematically showing the capacitor element of FIG. 7, wherein the capacitor element is partially cut off along lines A-A.

FIG. 9 is a set of plan views schematically showing a first substrate for the capacitor element of FIG. 7, wherein the left figure shows a first outer surface of the first substrate while the right figure shows a first inner surface of the first substrate.

FIG. 10 is a set of plan views schematically showing a second substrate for the capacitor element of FIG. 7, wherein the left figure shows a second outer surface of the second substrate while the right figure shows a second inner surface of the second substrate.

FIG. 11 is a cross-sectional view schematically showing a capacitor device according to a third embodiment of the present invention.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS

### First Embodiment

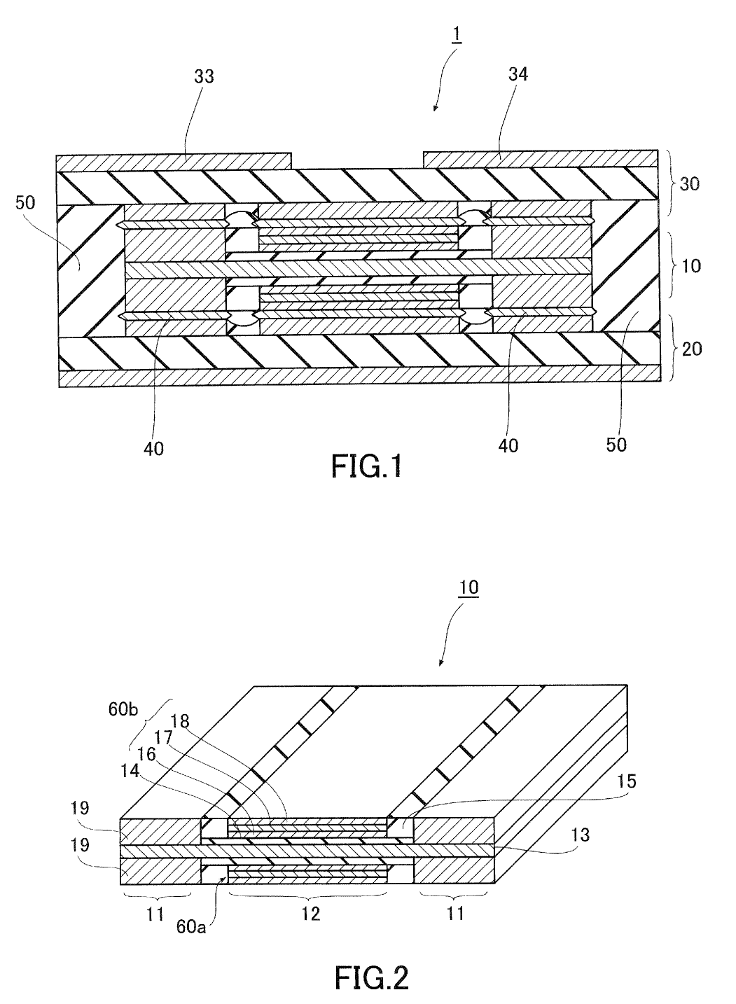

With reference to FIG. 1, a capacitor device 1 according to a first embodiment of the present invention comprises a capacitor element 10, a first substrate 20 and a second substrate 30. The capacitor element 10 is positioned between the first substrate 20 and the second substrate 30. For example, each of the first substrate 20 and the second substrate 30 may be mainly made of glass epoxy, liquid crystal polymer or polyimide.

With reference to FIG. 2, the capacitor element 10 comprises a base member 13, dielectric layers 14, dividers 15, a first cathode conductive layer 60a, a second cathode conductive layer 60b, and lead-frames 19.

In detail, the base member 13 is made of a valve metal. In this embodiment, the valve metal is aluminum so that the capacitor element 10 is an aluminum solid electrolytic capacitor element. The base member 13 generally has a plate shape or a film shape. In addition, the base member 13 of the present embodiment has a porous structure, i.e. a large surface area. The dielectric layers 14 of the present embodiment are oxide layers which are obtained by exposing a mother material of the base member 13 to a chemical conversion or chemical oxidization process. In this embodiment, the base member 13 with the dielectric layers 14 is an aluminum film with alumina layers and has a capacitance per unit area of 220 μF/cm², a nominal chemical conversion voltage of 3 V and a thickness of 70 μm.

The dividers 15 are formed on the dielectric layers 14 so that each dielectric layer 14 is divided into three regions; two end regions correspond to anode portions 11, while a middle region between the dividers 15 corresponds to a cathode portion 12. In this embodiment, the dividers 15 are made of insulator, specifically, resin such as epoxy resin. Note here that the end regions of the dielectric layers 14 are removed in a posterior process, as mentioned afterwards, so that the illustrated capacitor element 10 does not have the end regions of the dielectric layers 14 but has only the middle regions of the dielectric layers 14.

Each of the first cathode conductive layer 60a and the second cathode conductive layer 60b is formed on the dielectric layer 14, especially the middle region between the dividers 15 so that the first cathode conductive layer 60a and the second cathode conductive layer 60b are electrically insulated from the base member 13. The first cathode conductive layer 60a and the second cathode conductive layer 60b are electrically connected to each other on at least one end surface of the capacitor element 10. Each of the first cathode conductive layer 60a and the second cathode conductive layer 60b constitutes the cathode portion 12. Each of the first cathode conductive layer 60a and the second cathode conductive layer 60b of the present embodiment comprises a solid electrolyte layer 16, a graphite layer 17 and a silver layer 18 which are stacked in this order. In this embodiment, the solid electrolyte layer 16 is made of conductive polymer.

The end regions of the dielectric layers 14 are removed so that end regions of the base member 13 are exposed. On the exposed end regions of the base member 13, the lead-frames 19 are formed through an ultrasonic welding process. Each lead-frame 19 serves as an anode conductive layer which constitutes the anode portion 11. Each lead-frame 19 of the present embodiment is made of a Ni/Cu/Ag plated cupper film. Thus, the capacitor element 10 is obtained.

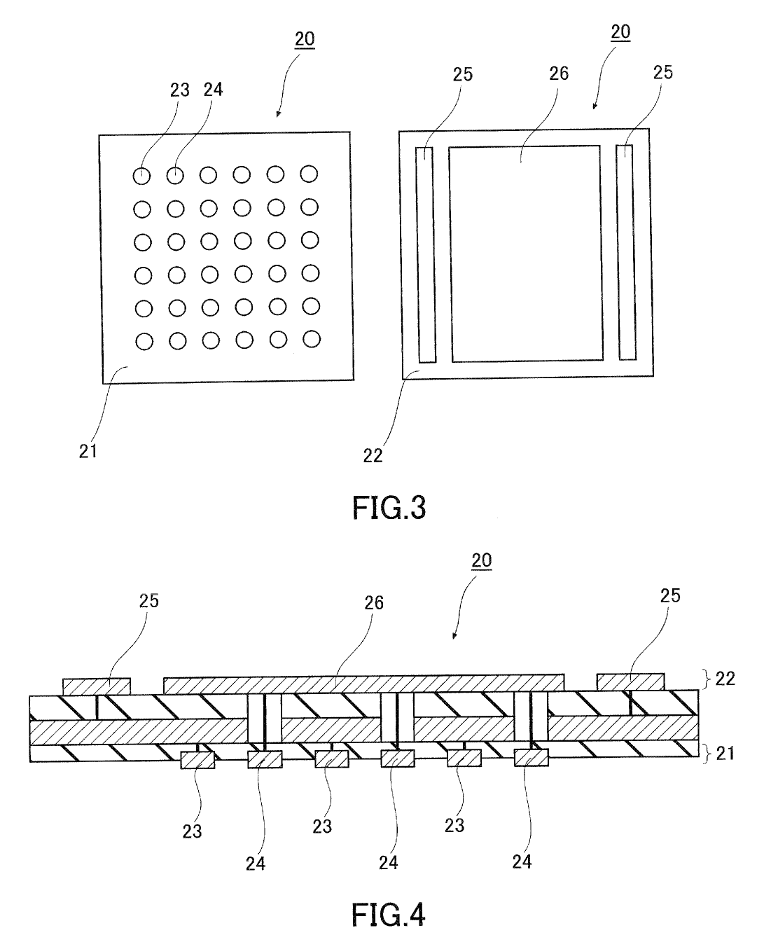

With reference to FIGS. 3 and 4, the first substrate 20 has a first outer surface 21 and a first inner surface 22. On the first inner surface 22, the capacitor element 10 is mounted (also see FIG. 1). The first outer surface 21 of the first substrate 20 according to the present embodiment is mounted on a circuit board when the capacitor device 1 is used. Needless to say, an IC may be connected to the first outer surface 21 directly or through a circuit board.

The first substrate 20 is provided with a first outer anode terminal, a first outer cathode terminal, first inner anode terminals 25 and a first inner cathode terminal 26. In this embodiment, the first outer anode terminal consists of first outer anode contacts 23, while the first outer cathode terminal consists of first outer cathode contacts 24. The first inner anode terminals 25 and the first inner cathode terminal 26 are formed on the first inner surface 22. The first inner anode terminals 25 are electrically connected to the anode portions 11, while the first inner cathode terminal 26 is electrically connected to the cathode portion 12, specifically, the first cathode conductive layer 60a (also see FIGS. 1 and 2). The connections between the first inner anode terminals 25 and the anode portions 11 and the connection between the first inner cathode terminal 26 and the cathode portion 12 are established by means of conductive adhesives 40 in the present embodiment (also see FIG. 1). The first outer anode contacts 23 and the first outer cathode contacts 24 are formed on the first outer surface 21. Specifically, the first outer anode contacts 23 and the first outer cathode contacts 24 are alternately arranged on the first outer surface 21 in accordance with the present embodiment. The first outer anode contacts 23 and the first outer cathode contacts 24 are electrically connected to the first inner anode terminal 25 and the first inner cathode terminal 26, respectively, by means of through-holes which are formed in the first substrate 20, as shown in FIG. 4.

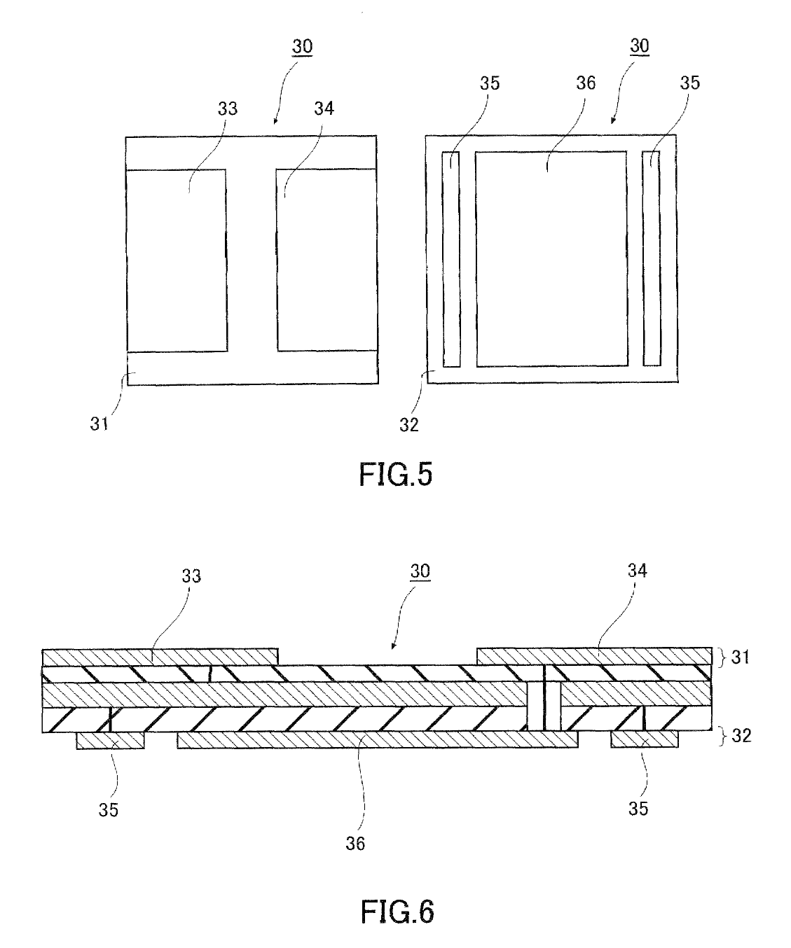

With reference to FIGS. 5 and 6, the second substrate 30 has a second outer surface 31 and a second inner surface 32. The second inner surface 32 is mounted on the capacitor element 10 (also see FIG. 1). The second outer surface 31 of the present embodiment is configured to mount an additional capacitor device thereon, as explained below. Therefore, the second outer surface 31 allows easy increase of a total capacitance per unit implementation area.

The second substrate 30 is provided with a second outer anode terminal 33, a second outer cathode terminal 34, second inner anode terminals 35 and a second inner cathode terminal 36. The second inner anode terminals 35 and the second inner cathode terminal 36 are formed on the second inner surface 32. The second inner anode terminals 35 are electrically connected to the anode portions 11, respectively, while the second inner cathode terminal 36 is electrically connected to the cathode portion 12, specifically, the second cathode conductive layer 60b (also see FIGS. 1 and 2). The connections between the second inner anode terminals 35 and the anode portions 11 and the connection between the second inner cathode terminal 36 and the cathode portion 12 are established by means of conductive adhesives 40 in the present embodiment (also see FIG. 1). The second outer anode terminal 33 and the second outer cathode terminal 34 are formed on the second outer surface 31. The second outer anode terminal 33 and the second outer cathode terminal 34 are electrically connected to the second inner anode terminals 35 and the second inner cathode terminal 36, respectively, by means of through-holes which are formed in the second substrate 30, as shown in FIG. 6.

In this embodiment, the number of the second outer anode terminal 33 is one, and the number of the second outer cathode terminal 34 is also one, as shown in FIG. 5. However, the present invention is not limited thereto. The number of the second outer anode terminal 33 may be two or more, and the number of the second outer cathode terminal 34 may be one or more. For example, if an additional capacitor device to be mounted on the capacitor device 1 has outer terminals similar to the capacitor element 10, the number of the second outer anode terminals 33 is two, while the number of the second outer cathode terminal 34 is one; in other words, they may have the same arrangement as that of the second inner anode terminals 35 and the second inner cathode terminal 36 of the present embodiment.

In this embodiment, the capacitor element 10 is fixed to the first substrate 20 and the second substrate 30 through a thermocompression bonding process by using the conductive adhesives 40. In addition, the capacitor element 10 fixed to the first substrate 20 and the second substrate 30 is covered by applying liquefied epoxy resin 50 to the peripherals of the capacitor element 10, followed by curing the epoxy resin 50. Thus, the capacitor device I of the present embodiment can be obtained, as shown in FIG. 1.

The capacitor device 1 of the present embodiment, especially the first substrate 20 has a multiple outer contact structure consisting of the first outer anode contacts 23 and the first outer cathode contacts 24, wherein the first outer anode contacts 23 and the first outer cathode contacts 24 are alternately arranged. The alternate arrangement of the first outer anode contacts 23 and the first outer cathode contacts 24 solves or decreases undesirable magnetic fields so that the capacitor device 1 can have a low ESL (Equivalent Series Inductance).

According to the present embodiment, the function of the capacitor device and the external connection function of the capacitor device are separated. Even if a circuit board and/or an additional capacitor device has a different arrangement or structure of electrodes, the design change of the first and/or the second substrate 20, 30 allows the different arrangement without changing the design of the capacitor element 10. In other words, the capacitor element 10 can be applicable to various kinds of circuit boards and/or additional capacitor devices only by changing the design of the first and/or the second substrate 20, 30. In addition, the capacitor element 10 can has a simple structure which has no through-holes therein. Therefore, the capacitor device of the present embodiment has a reliable capacitance function with low cost.

### Second Embodiment

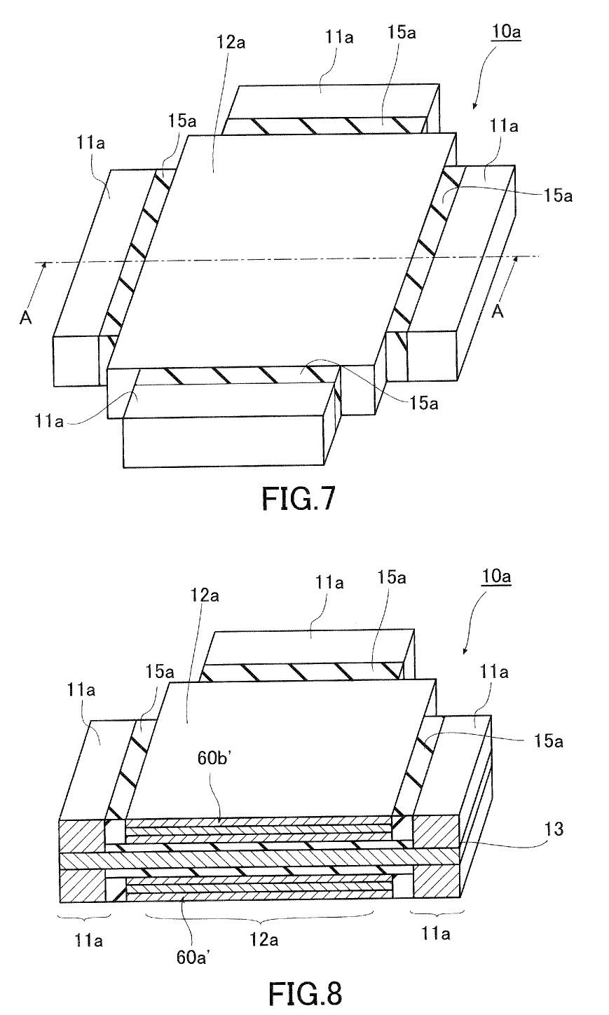

With reference to FIGS. 7 to 10, a capacitor device according to a second embodiment of the present invention is a modification of the above-mentioned capacitor device of the first embodiment. Therefore, in FIGS. 7 to 10, the similar reference numbers are given to the structures same as or similar to those of the capacitor device of the first embodiment. For example, dividers 15a correspond to the dividers 15 of the first embodiment. In this connection, the description will be directed only to the differences between the first and the second embodiments.

With reference to FIGS. 7 and 8, a capacitor element 10a of the present embodiment comprises, as an anode portion, a plurality of anode sections 11a. The anode sections 11a are formed on four end portions of the base member 13. The anode sections 11a of the present embodiment are arranged around a cathode portion 12a, i.e. first and second cathode conductive layers 60a′, 60b′, as seen along a direction perpendicular to the base member 13. The first and second cathode conductive layers 60a′, 60b′ are electrically connected to each other, the mutual connection is established on and around the corners of the square-shaped cathode portion 12a.

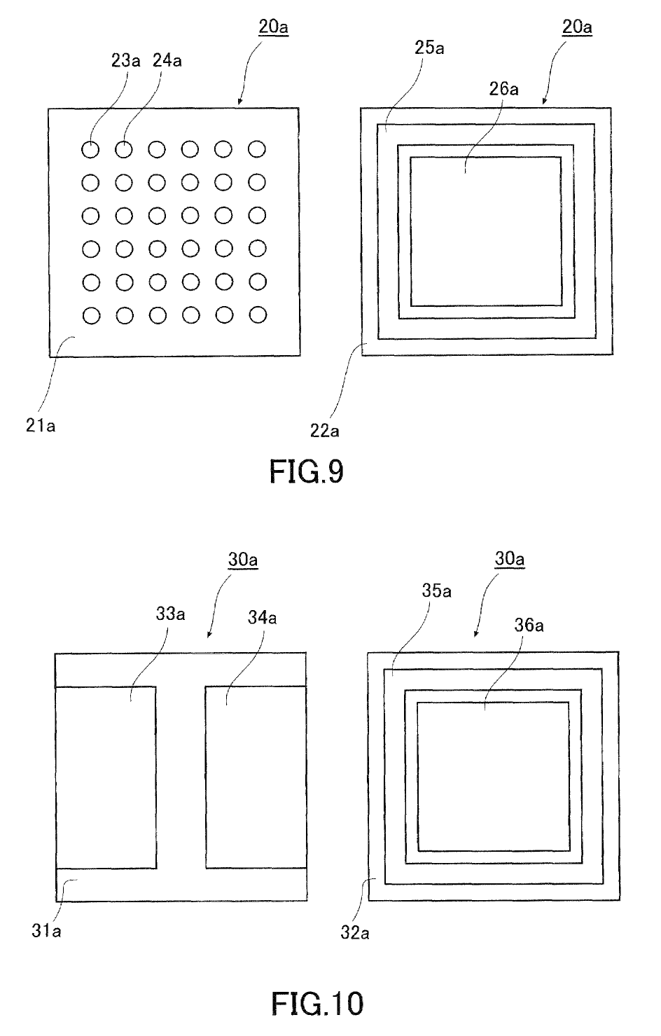

With reference to FIG. 9, a first substrate 20a has an arrangement of a first inner anode terminal 25a and a first inner cathode terminal 26a specified for the capacitor element 10a, although a plurality of first outer anode contacts 23a and a plurality of first outer cathode contacts 24a are alternately arranged on a first outer surface 21a in the same manner as the first embodiment. In detail, the first inner cathode terminal 26a has a square shape, while the first inner anode terminal 25a has a rectangular frame shape surrounding the first inner cathode terminal 26a on a first inner surface 22a, as seen along the perpendicular direction.

With reference to FIG. 10, a second substrate 30a has an arrangement of a second inner anode terminal 35a and a second inner cathode terminal 36a specified for the capacitor element 10a, although a second outer anode terminal 33a and a second outer cathode terminal 34a have the same arrangement as the first embodiment on a second outer surface 31a. In detail, the second inner cathode terminal 36a has a square shape, while the second inner anode terminal 35a has a rectangular frame shape surrounding the second inner cathode terminal 36a on a second inner surface 32a, as seen along the perpendicular direction.

The capacitor element 10a and the first substrate 20a of the present embodiment can decrease an ESL value in comparison with the first embodiment.

### Third Embodiment

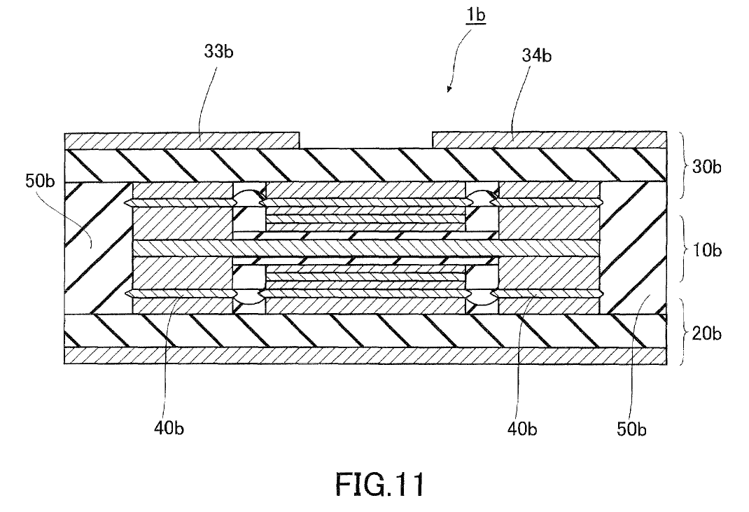

With reference to FIG. 11, a capacitor device 1b according to a third embodiment of the present invention is a modification of the above-mentioned capacitor device of the first embodiment. Therefore, in FIG. 11, the similar reference numbers are given to the structures same as or similar to those of the capacitor device of the first embodiment. For example, second outer anode terminal 33b and second outer cathode terminal 34b correspond to the second outer anode terminal 33 and the second outer cathode terminal 34 In this connection, the description will be directed only to the differences between the first and the third embodiments.

Instead of the liquefied epoxy resin 50, a frame-shaped pre-impregnation sheet 50b is used in the present embodiment. Specifically, a pre-impregnation sheet is stamped out so that the frame-shaped pre-impregnation sheet 50b is obtained. The frame-shaped pre-impregnation sheet 50b has an opening which corresponds to the outer shape of a capacitor element 10b of the present embodiment. In the frame-shaped pre-impregnation sheet 50b, the capacitor element 10b is placed. Then, first and second substrates 20b, 30b are placed on top and bottom surfaces of the capacitor element 10b with conductive adhesives 40b applied on the predetermined positions such as contacts or terminals. It is preferable that the conductive adhesives 40b are semi-cured in this stage. Then, a thermocompression bonding process is carried out so that the capacitor device 1b is obtained. For example, the bonding press is carried out under a reduced pressure of 10 Torr and some press conditions of temperature: 170° C.; time: 30 min; and applied pressure: 0.5 MPa. The third embodiment can omit a covering process by using resin because the capacitor element 10b can be covered by the frame-shaped pre-impregnation sheet 50b simultaneously with the fixation process of the first and the second substrates 20b, 30b to the capacitor element 10b.

The present application is based on a Japanese patent application of JP2008-069520 filed before the Japan Patent Office on Mar. 18, 2008, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A capacitor device comprising:
a capacitor element comprising an anode portion and a cathode portion;
a first substrate having a first inner surface and a first outer surface and being provided with a first inner anode terminal, a first inner cathode terminal, a first outer anode terminal and a first outer cathode terminal, the capacitor element being mounted on the first inner surface of the first substrate, the first inner anode terminal and the first inner cathode terminal being formed on the first inner surface and being electrically connected to the anode portion and the cathode portion, respectively, the first outer anode terminal and the first outer cathode terminal being formed on the first outer surface and being electrically connected to the first inner anode terminal and the first inner cathode terminal, respectively; and
a second substrate having a second inner surface and a second outer surface and being provided with a second inner anode terminal, a second inner cathode terminal, a second outer anode terminal and a second outer cathode terminal, the second inner surface being mounted on the capacitor element so that the capacitor element is positioned between the first and the second substrates, the second inner anode terminal and the second inner cathode terminal being formed on the second inner surface and being electrically connected to the anode portion and the cathode portion, respectively, the second outer anode terminal and the second outer cathode terminal being formed on the second outer surface and being electrically connected to the second inner anode terminal and the second inner cathode terminal, respectively.

2. The capacitor device according to claim 1, the capacitor device being mounted on a circuit board when used, wherein:
the first substrate is configured to be mounted on the circuit board; and
the second substrate is configured to mount an additional capacitor device thereon.

3. The capacitor device according to claim 1, wherein the second outer anode terminal comprises two or more second outer anode contacts, while the second outer cathode terminal comprises one or more second outer cathode contacts.

4. The capacitor device according to claim 1, wherein.:
the first outer anode terminal comprises two or more first outer anode contacts.
the first outer cathode terminal comprises two or more first outer cathode contacts;
the first outer anode contacts and the first outer cathode contacts are alternately arranged on the first outer surface; and
the first substrate is further formed with a plurality of through-holes, through which the inner anode terminal and the inner cathode terminal are electrically connected to the outer anode contacts and the outer cathode contacts, respectively.

5. The capacitor device according to claim 1, wherein the capacitor element is a solid electrolytic capacitor which includes a base member made of a valve metal and a cathode conductive layer, the cathode conductive layer constituting the cathode portion, the cathode conductive layer including a solid electrolyte layer and being electrically insulated from the base member.

6. The capacitor device according to claim 5, wherein:
the base member has a plate shape or a film shape;
the capacitor element further comprises a dielectric layer;
the dielectric layer is formed on the base member and is made of an oxide of the valve metal;
the cathode conductive layer is formed on the dielectric layer; and
the base member is provided with anode conductive layers which are electrically connected to each other and constitute the anode portion, the anode conductive layers being connected to the first and the second inner anode terminals.

7. The capacitor device according to claim 6, wherein:
the cathode conductive layer comprises a first cathode conductive layer and a second cathode conductive layer;
the first cathode conductive layer is connected to the first inner cathode terminal;
the second cathode conductive layer is connected to the second inner cathode terminal; and
the first cathode conductive layer and the second cathode conductive layer are electrically connected to each other.

8. The capacitor device according to claim 6, wherein:
the anode portion comprises a plurality of anode sections, each of which is formed on an end portion of the base member; and
the anode sections are arranged around the cathode conductive layer, as seen along a direction perpendicular to the base member.

9. The capacitor device according to claim 1, wherein each of the first and the second substrates are mainly made of glass epoxy, liquid crystal polymer or polyimide.
